(19) United States
(12) Patent Application Publication
(10) Pub. No.: US 2008/0107886 A1
(43) Pub. Date: May 8, 2008

(54) Protective garments for firefighters

(76) Inventors: Ralph Birchard Lloyd, Fayetteville, NC (US); Christopher A. Bricker, Avondale, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/002,734

(22) Filed: Dec. 18, 2007

Related U.S. Application Data
(63) Continuation of application No. 11/186,446, filed on Jul. 21, 2005.
(60) Provisional application No. 60/591,246, filed on Jul. 26, 2004.

(51) Int. Cl. B32B 7/02

(52) U.S. Cl. 428/221; 521/27

(57) ABSTRACT

A protective garment for firefighters having a breathable moisture barrier layer film which is does not suffer destruction on exposure to the Thermal Protective Performance Test of the National Fire Protection Association 1971 Standard.

### FIELD OF THE INVENTION

This invention is in the field of protective garments for firefighters and others exposed to hot and mechanically harsh conditions.

### BACKGROUND OF THE INVENTION

Turnout gear commonly used by firefighters in the United States comprises three layers, each performing a distinct function. There is an outer shell fabric often made from flame resistant aramid fiber such as poly(meta-phenylene isophthalamide) (MPD-I), such as the fiber sold by the DuPont Company under the trademark Nomex®, or poly(paraphenylene terephthalamide) (PPD-T), such as the fiber sold by the DuPont Company under the trademark Kevlar®, or blends of those fibers with flame resistant fibers such as polybenzimidazoles (PBI) and p-phenylene-2,6-benzobisoxazole (PBO). The outer shell provides protection against physical damage by sharp objects or abrasive surfaces and protection from flame. Adjacent to the outer shell fabric is a moisture barrier. Common moisture barriers include a laminate of ePTFE (expanded polytetrafluoroethylene) membrane on a woven MPD-I/PPD-T substrate, such as the laminate sold as Crosstech® by W. L. Gore and Associates, or a laminate of neoprene on a fibrous woven polyester/cotton substrate. The moisture barrier keeps the firefighter dry when the outer shell is exposed to water. Neoprene is not a breathable moisture barrier, but more advanced moisture barriers such as Crosstech® help the wearer stay dry by allowing water vapor from perspiration to penetrate, reducing the amount of perspiration that is trapped within the garment. Adjacent to the moisture barrier is an insulating thermal liner which generally comprises a batt of heat resistant fiber.

NFPA (National Fire Protection Association) 1971 Standard on Protective Ensemble for Structural Fire Fighting, 2000 edition, includes a Thermal Protective Performance (TPP) Test §6-10 (p. 40ff) that protective garments must pass to obtain NFPA approval. When the above described garment construction containing ePTFE moisture barrier is subjected to the TPP test, the ePTFE component of the moisture barrier is lost in the region of heat exposure. It seems that the ePTFE shrinks back, decomposes, or is otherwise degraded. The effectiveness of the moisture barrier is decreased in those regions where the ePTFE layer is damaged due to heat exposure.

Improved moisture barrier material is needed that will maintain effectiveness during and after heat exposure, such as by the TPP test.

### SUMMARY OF THE INVENTION

The present invention provides a protective garment comprising an outer layer of flame resistant fabric, a breathable moisture barrier layer film comprised of a fluorinated ion-exchange polymer wherein the film is not destroyed when exposed to NFPA Thermal Protective Performance test, and a thermal insulating layer, the protective garment having a NFPA Thermal Protective Performance rating of greater than about 35 and a NFPA Total Heat Loss rating of greater than about 130 W/m².

### DETAILED DESCRIPTION

Expanded polytetrafluoroethylene (ePTFE) is known for its ability to transport water vapor and to resist the passage of water in the liquid state. ePTFE can be described as being breathable. Under the trademark Gore-tex®, ePTFE is used in outdoor wear. It is therefore natural that ePTFE would be a candidate for the moisture barrier in protective garments for wet environments where it is desirable or essential to keep the wearer dry while allowing water vapor arising from the wearer's perspiration to pass through the garment. In the performance of their duty firefighters are almost invariably exposed to water, and the strenuous nature of their work makes it probable that they will perspire freely.

The discovery that ePTFE does not survive when exposed to heat, as was found when examining the garment structure after the TPP test, shows that new breathable moisture barrier layer films are needed for turnout gear with higher heat resistance that will maintain their moisture barrier properties during and after exposure to heat, as shown by inspection after the TPP test.

It is found that a layer of fluorinated ion-exchange polymer, such as the type sold under the tradename Nafion®, provides breathability to permit water vapor to pass through while being a barrier to liquid water. Further, compared to ePTFE, Nafion® is not easily wetted or penetrated by hydrocarbon liquids.

The fluorinated ion exchange polymer employed in accordance with this invention preferably has anionic functionality, most preferably sulfonate functional groups, which may be in the hydrogen ion, ammonium ion, or metal ion form. Preferably, the polymer is in metal ion form in the garment, more preferably the sodium ion form. Preferably, the polymer comprises a polymer backbone with recurring side chains attached to the backbone, the side chains carrying the ion exchange groups. Preferably, there is at least one and more preferably two fluorine atoms attached to the carbon atom of the side chain to which the ion exchange group is attached. It is especially preferable to employ “highly fluorinated” ion exchange polymer. By “highly fluorinated” is meant that in the polymer in ion exchange form at least half the monovalent atoms bound to carbon atoms are fluorine atoms. The fluorinated ion exchange polymers can be copolymers of fluorinated monomers containing the sulfonic functional group with nonfunctional monomers, usually the predominant monomer in the polymer, referred to herein as fluoromonomer-based polymers. Examples of fluorinated monomers containing the sulfonic functional group (in precursor form) are the perfluorinated vinyl ethers CF₂═CF—O—CF₂CF(CF₃)—O—CF₂CF₂SO₂F, perfluoro(3,6-dioxa-4-methyl-7-octenesulfonyl fluoride) and CF₂═CF—O—CF₂CF₂SO₂F, perfluoro(3-oxa-4-pentenesulfonyl fluoride). Examples of nonfunctional fluoromonomers are tetrafluoroethylene, trifluoroethylene, vinylidene fluoride, vinyl fluoride and chlorotrifluoroethylene. The polymers employed in accordance with the present invention are preferably tetrafluoroethylene-based polymers, i.e., where the nonfunctional monomer is predominately tetrafluoroethylene. Most preferably, the polymers employed are perfluorinated. By perfluorinated is meant that substantially all the monovalent atoms bound to carbon atoms on the backbone of the polymer (the main chain) are fluorine atoms. Some of the monovalent atoms bound to carbon atoms at the end of the main chain may be hydrogen atoms, such as might be derived from chain transfer agents. Such polymers and their preparation are well-known in the art, and are described in U.S. Pat. Nos. 3,282,875, 4,358,545 and 4,940,525. In addition to having good water vapor transport properties, such polymers are unaffected by many of the chemicals used in decontamination of protective garments.

The fluorinated ion exchange polymer is characterized by equivalent weight, that is, the weight in grams of polymer in the hydrogen ion form that neutralize one equivalent of base, such as sodium hydroxide. The equivalent weight of fluorinated ion exchange polymer of this invention is about 500 to 1500, preferably about 700 to 1300, more preferably about 800 to 1200, still more preferably about 850 to 1150, and most preferably about 900 to 1100.

The fluorinated ion exchange polymer film used in making the moisture barrier layer may be prepared by extrusion of fluorinated ion exchange polymer. This is done with the polymer in a melt processible precursor form (the hydrogen ion or other ionic forms of fluorinate ion exchange polymers are not easily melt processed). The usual form for melt processing of a polymer having sulfonate functional groups is the sulfonyl fluoride form. After melt processing, the sulfonyl fluoride can be hydrolyzed to the sulfonic acid salt form by treatment with aqueous base, preferably potassium hydroxide (KOH), and preferably in the presence of a cosolvent, such as dimethyl sulfoxide (DMSO). A typical formulation is 10-15 wt % KOH, 10-15 wt % DMSO, and the balance water. Typical hydrolysis times and temperatures are 15-60 minutes at 50-90° C. The resulting fluorinated ion exchange polymer is in the potassium salt form and may be converted to other ionic forms by ion exchange with the appropriate solutions, e.g. 10-20 wt % aq. nitric acid if the hydrogen ion form is desired, 10-20 wt % aq. sodium chloride solution for the sodium ion form. After treatment, the film is washed with deionized water several times and dried at temperatures not exceeding about 150° C., preferably not exceeding 100° C.

Alternatively, film can be made by casting aqueous alcoholic solution of Nafion®, available from Aldrich Chemical Co. Milwaukee Wis. or DuPont Company, Wilmington Del. The solution dries to from film in the hydrogen ion form. This may be ion exchanged to make other ionic forms. Ion exchange is accomplished using an aqueous solution of from 1 to 10 wt % of a salt, oxide, or hydroxide of the desired cation, such as sodium chloride or sodium hydroxide if the sodium ion form is wanted. Oxides or hydroxides are preferred under conditions where their more or less high alkalinity can be tolerated. For ion exchange of the film when it is adhered to fabric, salt is preferred as less likely to affect the fabric adversely. Exchange is rapid, 0.5 to 10 hours being enough time. The exchanged film (and fabric if present) is rinsed 2 to 3 times in water to removes excess salt or hydroxide. All this is done at room temperature.

The garment construction in accordance with the invention is comprised of a protective outer layer of a flame resistant fabric, the breathable moisture barrier layer as discussed above that keeps water and harmful fluids from penetrating while permitting water vapor to pass from the vicinity of the wearer's body to the environment external to the garment, and a thermal layer to protect the wearer from heat. These three basic components may be combined in different ways, but the barrier layer is located so that the outershell protects it from mechanical damage, and it in turn protects the thermal layer from being contacted by water or other fluids originating outside the garment. Without intending to be limiting to the materials described or to exclude additional components or layers, the following describes various examples of materials which may be used to provide the layers:
A. An outer shell. Examples are Nomex® IIIA, a 7.5 oz/yd² (0.25 kg/m² plain weave blend of Nomex® and Kevlar® with carbon fiber; Advance®, a 7.5 oz/yd² (0.25 kg/m²) ripstop weave of 60% Kevlar® and 40% Nomex®, and Kevlar®/PBI, a ripstop weave of 60% Kevlar® and 40% PBI. These are available from Lion Apparel, Dayton Ohio USA.
B. A moisture barrier comprising a film that permits passage of water vapor but is substantially impermeable to water in the liquid state. The film according to the invention is comprised of fluorinated ion exchange polymer of about 0.1 to 5 mils (2.5 to 125 μm) thick, preferably about 0.5 to 3 mils (12 to 75 μm) thick, more preferably about 0.5 mil to 1.5 mils (12 to 37.5 μm) thick and most preferably 0.5 to 1 mil (12 to 25 μm). Commercial perfluorosulfonic acid resin solutions suitable for casting films for this use include the solutions sold as Nafion® DE 520, 521, 1020, 1021, 2020, and 2021, available from the DuPont Company. The fluorinated ion exchange polymer film is preferably adhered to a support fabric. The preferred method of adhering is to print or spray dots of adhesive on the fabric and to apply the fluorinated ion exchange polymer film to the adhesive dots. Polyurethane adhesives are preferred in this application and may be applied as melts, as solvent-based solutions, or as two-component reactive adhesives that cure in air, the humidity being the source of moisture that activates the isocyanate which then reacts with diol to from the urethane linkage.
   Though not necessary to the performance of the fluorinated ion-exchange polymer film according to this invention when exposed to the TTP test, the moisture barrier may additionally have one or more layers of breathable membrane to improve durability of the fluorinated ion-exchange polymer film. These membranes have good moisture vapor transmission rates (MTVR), for example preferably the MTVR is at least about 1 kgm²/24 hours for a 25 μm thick film. Commercial membranes of this type include a polyether block amide film extruded from PEBAX resins (Arkema) and a polyurethane based film sold by Omniflex under the “Transport” name (Omniflex, Greenfield Mass. USA). If a breathable membrane is used the thickness is preferably 1 to 10 μm. The breathable membrane layer (BML) with respect to the Nafion® layer may be arranged as follows:
   substrate/BMUNafion®; substrate/Nafion®/BML; or
   substrate/BMUNafion®/BML, where the substrate is the support fabric. The above steps are generally done with the fluorinated ion exchange polymer in the hydrogen ion (proton) form. Since it may be preferred that the fluorinated ion exchange polymer be in a metal ion form, for example the sodium ion form in the garment, the finished moisture barrier composition is soaked in an aqueous solution of 0.5 to 10 wt % of a convenient salt of the desired metal ion. To convert the fluorinated ion exchange polymer to the sodium ion form, the moisture barrier composition is soaked in aqueous sodium chloride solution. After soaking for 5 minutes to 24 hours, the composition is washed in water to remove excess salt, and dried.
C. A thermal layer. The layer may be made from Kevlar® or Nomex®, such as Southern Mills (Union City Ga. USA) Aralite® or Q-9. Other suppliers are Securitex (Montreal Canada), under the tradename “Ultraflex”, and DuPont's Nomex® Omega® Turnout System.

The protective garment in accordance with the present invention meets or exceeds ratings established by the NFPA (National Fire Protection Association) 1971 Standard on Protective Ensemble for Structural Fire Fighting, 2000 edition. The NFPA Thermal Protective Performance (TPP) test is done according to the procedure disclosed in NFPA 1971 Standard, 2000 edition, §6-10 on pp. 40-44. The NFPA TPP rating of the garment according to this invention is at least about 35, preferably at least about 38, and more preferably at least about 42. Breathability is determined using the NFPA Total Heat Loss (THL) test as disclosed in the NFPA 1971 Standard §6-34. The THL rating of the garment according to this invention is at least about 130 W/m², preferably at least about 150 W/m², more preferably at least about 200 W/m², still more preferably about 250 W/m², and most preferably about 300 W/m². In addition, as further illustrated in the examples which follow, the fluorinated ion-exchange polymer film is not destroyed when exposed to NFPA Thermal Protective Performance test.

By destroyed is meant that at least a 25% fraction total area of the breathable moisture barrier membrane exposed to the TTP test is missing afterward. The fluorinated ion-exchange polymer breathable moisture barrier layer film of this invention is not destroyed when exposed to the TPP test. It is found to be intact. It is understood that the film in the localized area exosed to the test may have reduced breathability but its primary function remains, i.e., to act as a barrier to water and other substances, protecting the wearer. In addition, some cracks may occur but these are not capable of passing significant amounts of water or other substances. The integrity of the barrier is maintained. In use, whaterver local loss of breathability because of a part of the garment's being exposed to high temperature, such as by warding off an ember or shouldering into a hot surface, will not significantly reduce the overall breathability of the garment. However, loss of the barrier over even a few square inches could allow passage of large amounts of water or other substances through the garment, affecting the wearer.

### EXAMPLES

The Nafion® perfluorinated ion exchange polymer used to make Nafion® films for use in Examples 1-4 is an acid form hydrolyzed copolymer of tetrafluoroethylene and perfluoro-3,6-dioxa-4-methyl-7-octenesulfonyl fluoride, 25 wt % in an aqueous-alcoholic solution that is about 25 wt % water and the balance 1-propanol, ethanol, and <3% other VOC's. The equivalent weight of the copolymer is 890 to 1100. The viscosity at 25° C. at a shear rate of 40 s⁻¹ is 1000-3000 mPa·s.

The Nafion® solution is cast on a Mylar® substrate and dried. The resulting Nafion® film is not removed from the Mylar® substrate until the film is to be applied in the course of making the moisture barrier component of the turnout coat. Except in Example 4 where the Nafion® film is left in proton form, after removal of the Mylar®, the Nafion® film on the fabric is exposed to an aqueous solution of the appropriate metal chloride, sodium or calcium in the Examples, (5 wt %) for 24 hours, and then rinsed in water three times to remove excess metal chloride.

### Comparative Example 1

Garment construction is
A. Outer shell is a 60:40 blend of Kevlar®/PBI, 7.5 oz/yd² (0.25 kg m²).
B. Moisture barrier: Crosstech® ePTFE-containing moisture barrier available from W. L. Gore and Associates, Newark Del. USA.
C. Aralite, a 3.3 oz/yd² (0.11 kg/m²) Nomex® face cloth quilted to 3.8 oz/yd² (0.13 kg/m²) Nomex® or Kevlar® aramid batting.
   The garment construction is subjected to the TPP test. Results are summarized in Table 1.

### Comparative Example 2

Comparative Example 1 is repeated in a second TPP test. Results are summarized in Table 1.

### Example 1

The garment construction is similar to that described in Comparative Example 1 except that in place of Crosstech®, the moisture barrier is 0.75 mil (19 μm) fluorinated ion-exchange polymer (Nafion® perfluorinated ionomer in the sodium ion form) capped with a monolithic polyurethane film and 12-13 mil (305-330 μm) 3.2 oz/yd² (108 g/m²) Nomex® pajamacheck fabric, the same substrate used in the Gore Crosstech® moisture barrier. A moisture-activated reactive polyurethane adhesive is printed in a dot pattern on the substrate and then 0.2 mil (5 μm) breathable polyurethane film (Transport TX1540 from Omniflex, Greenfield Mass. USA) is contacted to the adhesive. The adhesive is allowed to cure for two days, after which the polyethylene backing film is peeled away as the polyurethane bonds to the adhesive dots. Next, the cast Nafion® film on a Mylar® support is applied to the polyurethane film by thermal lamination, and then the Mylar® backing film is peeled away. The laminate is then immersed in a 1N solution of NaCl for several hours to convert the Nafion® ion exchange film to the sodium form.

The total garment fabric weight is 21.40 oz/yd² (0.726 kg/m²), thickness is 112 mils (2.84 mm). The garment construction is subjected to the TPP test. In these tests, the side of the Nomex® pajamacheck that is adhered to the fluorinated ion-exchange polymer is faced in, that is, faces the wearer. Results are summarized in Table 1.

### Example 2

A laminate similar to that described in Example 1 is constructed except that the moisture-activated reactive polyurethane adhesive is printed in a dot pattern on the substrate and then a 0.75 mil film of Nafion® cast on a Mylar® support is contacted to the adhesive. The adhesive is allowed to cure for two days, after which the Mylar® backing film is peeled away as the Nafion® bonds to the adhesive dots. Next, 0.2 mil (5 μm) breathable polyurethane film (Transport TX1540 from Omniflex, Greenfield Mass. USA) is bonded to the polyurethane by thermal lamination. The laminate is then immersed in a 1N solution of CaCl₂ for several hours to convert the Nafion® ion exchange film to the calcium form.

The total garment fabric weight is 21.2 oz/yd², (0.719 kg/m²) thickness is 117 mils (2.97 mm). The garment construction is subjected to the TPP test. In these tests, the side of the Nomex® pajamacheck that is adhered to the fluorinated ion-exchange polymer is faced in, that is, faces the wearer. Results are summarized in Table 1.

### Example 3

Example 2 is repeated with the difference that no polyurethane film is used. The total garment fabric weight is 20.9 oz/yd² (0.709 kg/m²) with a thickness of 116 mils (2.95 mm). Test results are summarized in Table 1.

### Example 4

Example 4 is similar to Example 1 except that the Nafion® film is 0.5 mil (13 μm) thick, the Nafion® is left in the proton (H⁺) form and not ion exchanged, and a second layer of 0.2 mil (5 μm) polyurethane (PU) film is thermally laminated to the exposed Nafion® side. The resulting structure of the moisture barrier is pajamacheck fabric/0.2 mil PU/0.5 mil Nafion/0.2 mil PU. The total garment fabric weight is 21.1 oz/yd² (0.715 kg/m²) and 112 mils (2.84 mm) thick. Test results are summarized in Table 1.

TABLE 1

| | | | | | Membrane |
|---|---|---|---|---|---|
| | | | | | Condition |
| | TPP Time | TPP Rating cal/cm² | | THL | After TPP |
| Example | (sec) | (kJ/m²) | | W/m² | Test |
| Comp. 1 | 22.08 | 39.50 | (1653) | >130 | Destroyed |
| Comp. 2 | 19.6 ± 0.85 | 38.8 ± 1.70 | (1624 ± 71) | >130 | Destroyed |
| 1 | 19.78 | 44.10 | (1845) | >130 | Intact |
| 2 | 21.4 ± 0.0 | 42.4 ± 0.14 | (1774 ± 6) | >130 | Intact |
| 3 | 21.85 ± 0.07 | 43.25 ± 0.21 | (1810 ± 9) | >130 | Intact |
| 4 | 20.0 ± 0.5 | 40.5 ± 0.8 | (1695 ± 33) | >130 | Intact |

Where “±” appears, the result is the mean of two measurements ± the standard deviation.

After the TPP test the components of the garment constructions are separated and the moisture barrier inspected. Table 1 indicates the ePTFE film of Comparative Examples 1 and 2 is destroyed since it is found to be missing in the central ˜60% of the area exposed to heat in the TPP test. The fluorinated ion-exchange polymer film of Examples 1, 2, 3, and 4 is indicated in Table 1 as being intact since it is still in place, somewhat darkened. Fluorinated ion-exchange polymer of this type is resistant to oxidation and to melting. The darkening may be due absorption by fluorinated ion-exchange polymer of decomposition products from other components of the garment construction. The fact that the fluorinated ion-exchange polymer film is still in place in Examples 1 through 4 further shows that the presence or absence, the position, and the number of layers of polyurethane do not influence the resistance of the fluorinated ion-exchange polymer film to degradation in the TPP test.

Table 1 shows that, in contrast to the Comparative Examples, when Nafion® is a component of the moisture barrier, the membrane remains intact after the TPP test. This is true even when the Nafion® layer is only 0.5 mil (13 μm) thick, and regardless of the counterion in the Nafion® layer (sodium, calcium, or proton).

The garment construction of the invention, as shown in Examples 1, 2, 3, and 4, has a TPP rating comparable to the construction of the Comparative Example.

The fact that fluorinated ion-exchange polymer remains in place after exposure to the TPP test demonstrates that its barrier properties survive exposure to high heat. Wearers of the garment construction comprising fluorinated ion-exchange polymer will be more protected against heat and water and chemical penetration compared to known garment constructions such as that illustrated in Comparative Examples 1 and 2. The garment construction of the Comparative Examples 1 and 2 loses the ePTFE barrier film on exposure the TPP test and as a result the garment loses its ability to protect the wearer from heat, water, or chemicals in the exposed area.

What is claimed is:

1. A protective garment comprising an outer layer of flame resistant fabric, a breathable moisture barrier layer film comprised of a fluorinated ion-exchange polymer wherein said film is not destroyed when exposed to NFPA Thermal Protective Performance test, and a thermal insulating layer, said protective garment having a NFPA Thermal Protective Performance rating of greater than about 35 and a NFPA Total Heat Loss rating of greater than about 130 W/m².

2. The protective garment of claim 1 wherein said breathable moisture barrier layer film has a thickness of about 0.1 mils to 5 mils (12 to 250 μm).

3. The protective garment of claim 1 wherein said flame resistant fabric of said outer layer comprises fiber selected from the group consisting of para-aramids, meta-aramids, polybenzimidazole, and p-phenylene-2,6-benzobisoxazole.

4. The protective garment of claim 1 wherein said thermal insulating layer is batting comprising fiber selected from at least one of the group consisting of para-aramids and meta-aramids.

5. The protective garment of claim 1 wherein said a fluorinated ion-exchange polymer is a tetrafluoroethylene-based polymer.

6. The garment of claim 1 wherein said breathable moisture barrier layer film comprises a highly fluorinated ion-exchange polymer.

7. The garment of claim 1 wherein said breathable moisture barrier layer film comprises a perfluorinated ion-exchange polymer.

8. The garment of claim 1 further comprising a fabric layer adhered to said breathable moisture barrier layer film.
